(19) United States
(12) Patent Application Publication
(10) Pub. No.: US 2016/0197399 A1
(43) Pub. Date: Jul. 7, 2016

(54) RADAR APPARATUS FOR A SHIP

(71) Applicant: KELVIN HUGHES LIMITED, Greater London (GB)

(72) Inventors: Terry DAVY, Enfield (UK); Kevin NORSTER, Enfield (UK); Barry WADE, Enfield (UK)

(21) Appl. No.: 14/916,747

(22) PCT Filed: Sep. 4, 2014
(86) PCT No.: PCT/GB2014/052662

§ 371 Date: Mar. 4, 2016

(30) Foreign Application Priority Data
Sep. 4, 2013 (GB) 1315752.4

(51) Int. Cl. H01Q 1/34; G01S 7/28; H01Q 3/04

(52) U.S. Cl. CPC H01Q 1/34; H01Q 3/04; G01S 7/28; G01S 2007/027

(57) ABSTRACT

A radar apparatus for a ship comprises a solid state transmitter and/or receiver enclosed within a housing, and an antenna coupled to the solid state transmitter and/or receiver. The external shape of the housing is substantially frusto-pyramidal. The frusto-pyramidal shape of the housing contributes to the robustness of the radar apparatus and allows the apparatus to have a low radar cross section.

The invention relates to a radar apparatus for a ship comprising a solid state transmitter, or a solid state receiver, or both a solid state transmitter and a solid state receiver, enclosed within a housing shaped to provide high strength and low radar cross-section.

### BACKGROUND TO THE INVENTION

In order to maximise the effective range of a radar system, it is preferred that radar signals are broadcast from a position that is high up on a ship, for example from the top of a mast or pole. For reasons of stability, however, it is undesirable to place too much weight at a high point on a ship. This leads to some conflicting technical requirements for radar apparatus.

A radar apparatus needs to be robust and needs to withstand certain standard controlled conditions. Robustness is particularly important in the field of military radar apparatus. Thus the housing of the radar needs to be tough and of high strength in order to protect the transmitter and/or receiver, and any associated components.

A further desirable feature of some radar apparatus is that of low detectability. This requirement, combined with the desirability that the weight at a high point of the ship is minimised, means that radar apparatus to be mounted high on a ship should be of minimal size. This is commonly achieved in radar apparatus by spatially separating the transmitter/receiver from the radar antenna. Thus, an antenna, and motor for driving the antenna, may be mounted at a high point on the ship, for example on a mast, and a transmitter/receiver may be located in a control room lower in the ship. This may be described as a radar apparatus with a down-mast transmitter/receiver. The signal between the antenna and the transmitter/receiver is carried by a wave guide that runs between the two components of the radar apparatus. Separation of the transmitter/receiver and antenna leads to further problems, however. A long wave guide run requires a more powerful transmitter as there may be considerable losses through the wave guide run. Likewise, losses in an extensive wave guide run mean that the apparatus lacks sensitivity, as received signals need to be more powerful to be detected due to losses in the wave guide run. Further potential problems associated with long wave guide runs include the up-mast weight of the wave guide itself, and the problem that reflection and bounce of a signal along the wave guide may disadvantageously increase the minimum range of the radar apparatus.

### SUMMARY OF INVENTION

The invention provides a radar apparatus for a ship as defined in the independent claims to which reference should now be made. Preferred or advantageous features of the invention are set out in various dependent sub-claims.

Thus, a radar apparatus for a ship comprises a solid state transmitter and/or solid state receiver enclosed within a housing. Both transmission and reception may be effected by a single solid state transceiver. An antenna is coupled to the solid state transmitter and/or receiver. The external shape of the housing is substantially frusto-pyramidal.

The radar apparatus may be an apparatus solely for transmitting and broadcasting a signal. In this case the radar apparatus may simply comprise a solid state transmitter enclosed within a housing. Alternatively, the radar apparatus may be solely for receiving radar signals. In this case the radar apparatus for a ship will comprise a solid state receiver enclosed within a housing. It is anticipated, however, that preferred embodiments of a radar apparatus for a ship will be used for both transmitting and receiving radar signals. In this case the apparatus may comprise both a solid state transmitter and a solid state receiver, or a single solid state transceiver for both transmitting and receiving a radar signal.

Thus, in preferred embodiments a radar apparatus for a ship comprises a solid state transmitter for generating pulses of energy, the solid state transmitter being enclosed within the housing. A solid state transceiver is intended to be an example of a solid state transmitter, and thus references below to a solid state transmitter include references to a solid state transceiver. An antenna is preferably supported by the housing, the antenna being electrically coupled to the solid state transmitter for radiating the pulses of energy generated by the transmitter or transceiver. The frusto-pyramidal shape of the housing contributes to the robustness of the radar apparatus and allows the apparatus to have a low radar cross section.

Geometrically, a pyramid is a polyhedral three-dimensional shape formed by connecting a polygonal base with a point in space known as the apex. A frustum is truncated pyramid.

As used herein the term frusto-pyramidal refers to the portion of a solid pyramid lying between two planes cutting through the pyramid. The planes do not need to be parallel, although it is preferred that they are substantially parallel. The base of the frusto-pyramid is preferably polygonal. In other words, the shape of the base preferably has a number of corners joined by curves. The curves joining the corners are preferably substantially straight lines but may have a determinable radius of curvature. The frusto-pyramid may be an oblique frusto-pyramid, but is preferably a right frusto-pyramid. Although a wide variety of substantially frusto-pyramidal shapes may be used to form the housing of the radar apparatus, it is preferred that the external shape presented by the housing is as simple as possible. Thus, it is preferred that the external shape of the housing is substantially a pentagonal-based frusto-pyramid, or a hexagonal-based frusto-pyramid, or a heptagonal-based frusto-pyramid.

There are a number of advantages in the use of a housing having an external shape that is substantially frusto-pyramidal. One of these advantages is that the shape imparts high strength to the housing. A ship's radar apparatus needs to be robust and the housing needs to protect the internal portions of the apparatus from the environment under operational stresses and strains. A ship's radar apparatus will be required to withstand highly stressed conditions, for example as maybe caused by rough seas or, in the case of military radar apparatus, explosive shocks. A frusto-pyramidal shaped housing provides high strength in which stresses applied to one part of the housing are spread efficiently to other parts of the housing. A substantially frusto-pyramidal shape may also provide an angular external shape which deflects radio frequency energy and lowers the radar cross-section of the apparatus. This may be particularly advantageous in order to reduce the visibility of the radar apparatus to other radars.

As stated above, it is preferred that the housing is shaped as a regular right frusto-pyramid having a substantially pentagonal, hexagonal or heptagonal base located on a first plane. The base of the frusto-pyramid may have more than seven sides but such a housing may then have a larger radar cross-section, and may be more difficult to construct than a housing in the form of a frusto-pyramid having a five, six, or seven sided base. The housing defines a number of side-faces, which are preferably substantially flat faces. In the preferred embodiments the housing has five, six, or seven side-faces each of which is angled with respect to the perpendicular of the first plane on which the base is located. Thus, the housing may be shaped as a frusto-pyramid having a base defined on a first plane, a top face defined on a second plane that is substantially parallel to the first plane and a plurality of side-faces each angled at between 10 degrees and 35 degrees from a direction perpendicular to the first plane. When mounted for use, it is envisaged that the base of the housing will be substantially horizontal and the direction perpendicular to the base will be substantially vertical, taking into account the natural pitch and roll of a ship. Thus, in use it may be preferred that the side faces are angled at between 10 degrees and 35 degrees from vertical.

There is a trade-off between the ability of the housing to deflect incoming radar signals and the strength provided by the housing. If the angle of the side-faces with respect to the perpendicular of the first plane is increased beyond 35 degrees, the radar cross-section advantageously diminishes, but the strength disadvantageously diminishes. Likewise, if the side-faces are angled at lower than 10 degrees from the direction perpendicular to the first plane then the faces are not sufficiently angled to deflect radar signals and the apparatus has a large radar cross-section. It may be particularly preferred that the side-faces are angled at between 12 degrees and 30 degrees from a direction perpendicular to the first plane. It may be particularly preferable that the plurality of side-faces are angled at between 13 degrees and 17 degrees from a direction perpendicular to the first plane, for example substantially 15 degrees from a direction perpendicular to the first plane.

It is advantageous if the housing has a substantially monocoque structure in order to increase the strength of the housing. For example, the housing may have a monocoque structure in which edges defining the frusto-pyramidal shape of the housing are a unitary component formed from composite materials. It is particularly preferred if the edges defining the frusto-pyramidal shape of the housing and at least three side-faces of the housing are formed as a unitary component from a composite material. In such embodiments a substantial proportion of the housing acts as a shell, and stresses and strains developed due to external influences are spread through the shell. It is particularly preferred that the composite material used for construction of the housing is a carbon fibre material. Carbon fibre composite materials have the combined advantage of light weight and electrical conductivity. Other composites such as glass fibre composites may be suitable for construction of a monocoque housing, although the weight of glass fibre is increased compared with carbon fibre and the electrical properties of carbon fibre would need to be sacrificed.

Preferably the housing comprises means for electro-magnetically shielding the solid state transmitter and/or receiver, and other internal electrical components of the radar apparatus, from the external environment. Electro-magnetic emissions may decrease the stealth capability of the radar apparatus as they may be detectable by other systems. Furthermore, electro-magnetic emissions may interfere with incoming and outgoing radar signals.

A structure formed largely from carbon fibre composite provides a certain degree of electro-magnetic shielding of the electronic components of the radar apparatus. The electro-magnetic insulation is preferably further augmented by the use of electro-magnetic seals, such as conductive rubber seals, on any external joints. Particularly preferably any external joint has both weather-tight seals and electro-magnetic seals in order to fully insulate the radar apparatus from the external environment.

While the external shape formed by the top-face and side-faces of the housing is substantially frusto-pyramidal, the strength of the housing may be improved by shaping the bottom-face of the housing. Thus, it may be particularly advantageous if the bottom-face of the housing is defined, at least in part, by a re-entrant surface to improve structural rigidity of the housing. Thus, the radar apparatus may have a housing which is externally defined by a top-face and side-faces shaped as a first frusto-pyramid having a base defined on a first plane and side-faces angled between 10 degrees and 35 degrees from a direction perpendicular to the first plane. The housing may also have a re-entrant or concave bottom-face substantially shaped as a second frusto-pyramid having the same base as the first frusto pyramid and side faces angled between 45 degrees and 90 degrees from the direction perpendicular to the first plane. In effect, the housing could be described as having an external portion shaped as a first frusto-pyramid and a re-entrant bottom portion shaped as a second frusto-pyramid having the same base as the first frusto-pyramid.

The reason for forming the bottom-face of the housing as a second, shallow, frusto-pyramid is to provide more area on the base and to stiffen the housing. Shocks from above and below the housing, such as may be instigated by heavy waves, may cause components of the radar apparatus mounted within the housing to be violently agitated up and down. The shaped bottom surface of the housing may act to stiffen the housing structure and help prevent deformation of the bottom face or panel of the housing when loaded from within.

A solid state transmitter, receiver, or transceiver generates heat. This heat is preferably removed from the housing. Thus, it is preferred that the solid state transmitter and/or receiver is mounted in contact with a means for removing heat from the housing. Such means is preferably a heat sink or heat guide extending from an internal portion of the housing to an external portion of the housing. In preferred embodiments the solid state transmitter and/or receiver is mounted in contact with a metallic heat sink located at a bottom panel of the housing. The heat sink preferably comprises a lightweight high thermal capacity material such as aluminium or magnesium and extends through the bottom-face of the housing so that heat generated by the solid state unit may be transferred to the external environment. The heat sink may comprise a radiator in order to efficiently dissipate heat generated by the solid state unit to the external environment.

Preferred embodiments of the radar apparatus further comprise a motor located within the housing. The motor is mechanically couplable to the antenna for rotating the antenna. Many traditional motor units for driving an antenna include a gearbox. In preferred embodiments of the radar apparatus the housing locates a motor for driving an antenna, and the motor directly drives the antenna without the use of a gearbox. Preferably the motor is a direct drive motor operating in the range of 6 to 60 rpm. The antenna for broadcasting the radar signal is preferably coupled to the motor by means of a yoke. Traditionally a yoke for a radar antenna is formed of a material such as aluminium. In preferred embodiments of the present application the yoke is a formed from a composite, for example a carbon fibre composite. The weight of a carbon fibre composite yoke may be one-fifth that of an equivalent strength aluminium yoke. Particularly preferably the yoke comprises angled faces to lower the radar cross-section of the radar apparatus. A wave guide couples the antenna to the solid state transmitter and/or receiver through a rotating joint.

Preferably the radar apparatus comprises further electronics located within the housing. The skilled person will be aware of the electronics required to cooperate with a solid state transmitter/receiver in order to form a functional radar apparatus. For example, the radar apparatus preferably comprises an inverter for converting a single phase power supply to three phase supply, preferably a modulated three phase supply, for driving the motor. Preferably the apparatus comprises an AC to DC converter for supplying power to the solid state transmitter and/or receiver.

As described above, the housing has an external shape that is substantially frusta-pyramidal, and this housing preferably defines between 5 and 7 side-faces. In particularly preferred embodiments at least one side-face defines an opening into the housing. Thus, preferably at least one side-face comprises a removable panel to provide access to the housing for loading and unloading components into the housing and for maintenance of components. In further preferred embodiments a second face may comprise a removable panel having an external surface and an internal surface. The internal surface preferably locates electronic components such as an AC/DC converter or an inverter.

Electronic components located on the internal surface of the panel may be advantageously removed from the housing when the panel is removed to facilitate maintenance.

In a particularly preferred embodiment of the radar apparatus, the housing is substantially frusto-pyramidal in shape having between 5 and 7 side-faces. One of the side-faces defines an access opening and comprises a removable panel for access to the internal portions of the housing. One other of the side-faces comprises a removable panel locating an AC/DC converter on an internal surface to facilitate removal and maintenance of the AC/DC converter. A third side-face comprises a removable panel having an internal surface locating an inverter. Remaining side-faces of the housing do not comprise removable panels. Preferably the opening closed by each removable panel is sealed with both weather seals and electromagnetic seals. Where electronic components are located on an internal surface of a removable panel, that panel effectively acts as a rack for the electronic components. This enables components, such as inverters and converters, to be pre-assembled and easily removed and accessed for maintenance.

Preferably the radar apparatus is supplied with power by a single power cable.

Particularly preferably output of the radar apparatus is supplied along a fibre optic cable to minimise electromagnetic losses.

The use of a frusta-pyramidal shaped housing allows the housing to be both lightweight, high strength, and low radar cross-section. Preferred embodiments, which may include one or more of the preferred or advantageous features described above, provide a stealthy, lightweight, up-mast ship's radar apparatus having an up-mast transmitter and/or receiver to increase performance and reduce electromagnetic losses. It is preferred that the apparatus has an up-mast weight of less than 100 kg, preferably less than 80 kg or less than 60 kg. Particularly preferred embodiments will have an up-mast weight of less than 55 kg or less than 50 kg.

### PREFERRED EMBODIMENT OF THE INVENTION

Preferred embodiments of the invention will now be described with reference to figures in which

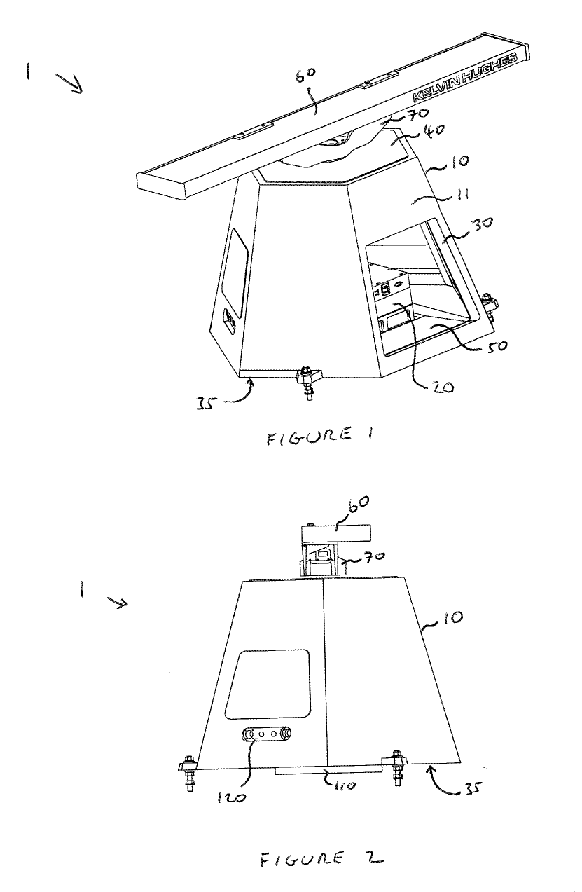

FIG. 1 shows a perspective view of a radar apparatus according to a specific embodiment of the invention;

FIG. 2 shows a side view of the radar apparatus of FIG. 1;

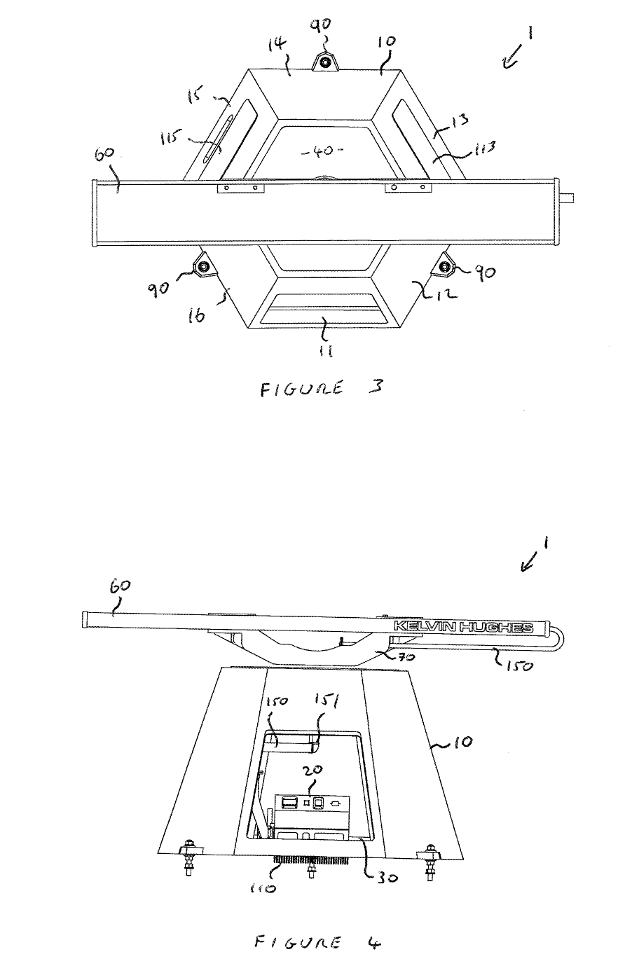

FIG. 3 shows a top plan view of the radar apparatus of FIG. 1;

FIG. 4 shows a front view of the radar apparatus of FIG. 1;

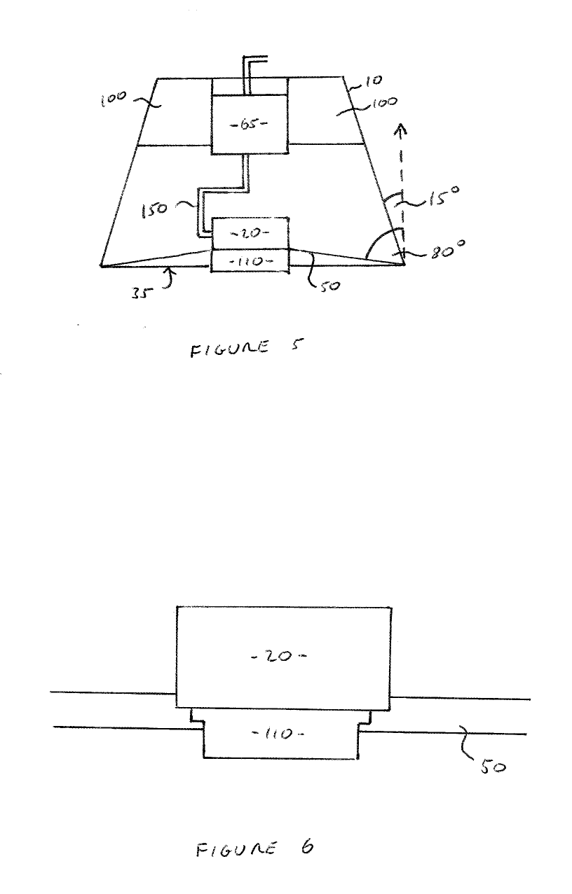

FIG. 5 illustrates a schematic cross-sectional view of a housing of the radar apparatus of FIG. 1 showing positions of a solid state transceiver and a motor within the housing;

FIG. 6 is a schematic illustration showing a solid state transceiver mounted on a heat sink extending through a portion of a housing, as may be used in the radar apparatus of FIG. 1.

FIGS. 1 to 4 illustrate a preferred embodiment of a radar apparatus 1 according to a specific embodiment of the invention. The radar apparatus 1 is a radar apparatus for a ship, and in particular a lightweight low radar cross-section (rcs) radar apparatus for a ship. The radar apparatus comprises a housing 10 enclosing a solid state transceiver 20 for transmitting and receiving pulses of energy. The solid state transceiver 20 is visible in FIGS. 1 and 4 through an access opening 30 defined through a side-face 11 of the housing 10. In use, the access opening 30 would be sealed by a removable panel or cover (not shown). The radar apparatus also comprises a motor 65, and an antenna 60 coupled to the motor 65 via a yoke 70.

The housing 10 is shaped as a hexagonal-based frusto-pyramid. Thus, the housing is shaped as a truncated hexagonal-based pyramid in which the base is a regular hexagon. The housing 10 thus has an external shape defined by base 35 shaped as a regular hexagon located in a first plane, a top face 40, also hexagonally shaped, located in a second plane parallel to the first plane. The housing further defines six side faces 11, 12, 13, 14, 15, and 16 extending vertically upwards from the base 35 and converging upon a single point (the apex) at an angle of 15 degrees from a direction perpendicular to the first plane. The angle of incline of the side faces is illustrated in FIG. 5.

A bottom-face 50 of the housing is shaped as a shallow hexagonal-based frusto-pyramid having the same hexagonal base 35 as the first frusto-pyramid. As can be seen by FIG. 5, the faces of the second, shallow, frusto-pyramid forming a portion of the bottom of the housing 50 are angled at 80 degrees from a direction perpendicular to the first plane. Thus, the bottom-face of the housing forms a re-entrant shape extending concavely into the frusto-pyramid formed by the side walls 11, 12, 13, 14, 15, and 16 and top face 40. The radar apparatus further comprises an antenna 60 coupled to a motor 65 via a yoke 70.

A substantial portion of the housing 10 is formed as unitary, or monocoque, structure from carbon fibre composite and foam. The skilled person will be aware of ways to construct a lightweight unitary structure from carbon fibre and foam. Thus, struts forming edges of the hexagonal frusta-pyramidal shape of the housing 10 are formed using a rigid polymeric foam wrapped with carbon fibre and then cured to form a substantially unitary housing having the shape as described above. Side faces 11, 12, 13, 14, 15, and 16 of the housing 10 are formed by cross-ply carbon fibre composite laid at 45 degrees from vertical in order to maximise torsional rigidity of the housing 10. This construction may be used in any embodiment of the invention described above.

Removable panels 113, 115 close openings defined in three of the side faces 11, 13, and 15. A first removable panel (not shown) acts as a cover for the first access opening 30. This removable panel allows access to the internal portions of the housing in order to install components and carry out maintenance.

A second removable panel 113 covers a second opening and acts as a removable rack for an inverter. Thus, an inverter (not shown) is mounted on an inner surface of the second removable panel 113 to facilitate installation and removal of the inverter from the radar apparatus. The inverter acts to convert a single phase power supply to a three phase supply to drive the motor 65.

A third removable panel 115 covers a third opening and acts as a rack for an AC/DC converter. The AC/DC converter is mounted on an internal face of the removable panel 115 to facilitate installation and removal from the radar apparatus. The AC/DC converter is used to convert a power supply for supplying power to the solid state transceiver.

The use of removable panels as racks for electrical components allows easy installation and maintenance of components and also allows components such as an inverter or an AC converter to be swiftly replaced by a maintenance engineer while spending minimal time up-mast.

Three side-faces 12, 14, 16 of the housing 10 do not define removable panels. The presence of these side faces increases the strength and rigidity of the housing 10. The housing 10 has six side-faces, three of which define openings closed by removable panels and three of which do not define openings. In order to maximise the strength of the housing the panels defining openings into the housing are alternated with panels that do not have openings into the housing. Thus, each side-face defining an opening into the housing 11, 13, 15 is arranged to be adjacent to two of the panels that do not define openings into the housing 12, 14, 16.

Connection ports 120 defined through a side-face of the apparatus allow power supply into the housing 10 and an optic fibre output connection.

The antenna may be any suitable radar antenna for propagating pulses of energy. Preferably the antenna is a marine radar antenna. A suitable antenna may be as disclosed in EP 1313167, which describes a low profile antenna. The disclosure of EP 1313167 is incorporated herein in its entirety.

The solid state transceiver preferably transmits groups of pulses of energy in order to maximise the detection of marine targets at different ranges.

A particularly preferred solid state transmitter/transceiver may function as described in U.S. Pat. No. 7,764,223 B, the disclosure of which is incorporated herein in its entirety. In the radar apparatus disclosed in U.S. Pat. No. 7,764,223 B a transmitter propagates groups of pulses of energy including three pulses of different widths, in which there is a spacing between each of the pulses, the shorter pulse enabling detection of close range targets and the longer pulses enabling detecting of longer range targets, wherein the different length pulses are encoded differently from one another. The radar apparatus of U.S. Pat. No. 7,764,223 further includes a processor for generating Doppler information which, when used in conjunction with the groups of pulses of energy propagated by the transmitter, allows typical marine targets of different speeds to be identified. Such a device may comprise part of any embodiment of a radar apparatus disclosed herein, A suitable device is supplied by Kelvin Hughes under the trade mark SHARPEYE®.

Pulses of energy generated by the solid state transceiver 20 are passed along a wave guide, which includes a rotating joint 151, and to the antenna 60 where the energy can be propagated. As the solid state transceiver 20 is located up-mast in proximity to the antenna 60 there is minimal wave guide run and, therefore, there are minimal losses in power between the solid state transceiver 20 and the antenna 60. Likewise, the radar apparatus 1 is more sensitive to weak received signals, as minimal power from the received signals is lost in the wave guide run.

The solid state transceiver 20 is mounted in contact with a heat sink 110 for removal of thermal energy generated by the transceiver 20. The heat sink 110 is formed from an aluminium alloy and extends to the external environment outside the housing. Radiator fins defined in a lower surface of the heat sink 110 act to dissipate heat to the environment. FIG. 6 illustrates a preferred configuration for mounting the heat sink 110 and solid state transceiver 20 in a bottom-face 50 of the housing 10. The stepped configuration of the heat sink 110 allows efficient sealing of the internal portions of the housing from the environment.

The motor 65 directly drives the yoke 70, and the antenna 60 attached to the yoke. The motor is linked by a direct drive in order to reduce weight that would be associated with a gearbox. Preferably the speed of the antenna may be varied by modulating the power input. Preferably the antenna can rotate at speeds between 6 and 60 revolutions per minute (rpm).

The yoke 70 in the specifically preferred embodiment is formed as a single component from carbon fibre composite.

The apparatus is attached or mounted to a mast or pole of a ship by means of three feet 90. The use of three feet allows the apparatus to be self leveling. Each of the three feet is located on the base of the housing 10 in a central portion of one of the side faces that does not define an opening 12, 14, 16 into the housing 10. The feet 90 may act to raise the housing 10 when mounted in order to allow an air flow to the bottom of the apparatus. The motor 65 is located within an upper portion of the housing 10 and is held in a central position by means of polymeric foam 100. The foam 100 provides a lightweight means of anchoring the motor 65 in its working position.

In this preferred embodiment all openings to the housing, for example the removable side-panels 113,115, the heat sink 110, power inputs and signal outputs, and the extension of the wave guide through the top face 40 of the housing 10, are sealed by both weather seals, to keep out salt water, and electromagnetic seals, to prevent leak of electromagnetic radiation.

The radar apparatus according to this specific embodiment of the radar apparatus as described above according to any embodiment of the invention, provides a lightweight, high strength, up-mast ship's radar apparatus that combines advantageous features of low up-mast weight, low radar cross-section, and low electromagnetic radiation leakage. The proximity of a solid state transmitter and antenna allows the elimination of a long wave guide run, which itself reduces the up-mast weight of the radar apparatus. The weight of the radar apparatus according to the specific embodiment described above is about 55 kilograms. The frusto-pyramidal shape of the housing acts to both increase strength of the housing and decrease radar cross-section. The selection of carbon fibre composite for the construction of the housing allows both a high strength and stiffness and provides for electromagnetic shielding of electrical components within the radar apparatus. The features defined herein combine synergistically to provide a significantly improved up-mast ship's radar apparatus.

1. A radar apparatus for a ship comprising,
a solid state transmitter and/or receiver enclosed within a housing, and an antenna coupled to the solid state transmitter and/or receiver, in which the external shape of the housing is substantially frusto-pyramidal.

2. A radar apparatus according to claim 1 comprising a solid state transmitter for generating pulses of energy enclosed within the housing, and
an antenna supported by the housing, the antenna being electrically coupled to the solid state transmitter for radiating the pulses of energy, in which the external shape of the housing is substantially frusto-pyramidal.

3. A radar apparatus according to claim 1 in which the external shape of the housing is a pentagonal-based, hexagonal-based, or heptagonal-based frusto-pyramid.

4. A radar apparatus according to claim 1, in which the housing is shaped as a frusto-pyramid, the base of the frusto-pyramid being defined on a first plane, the housing having a top face defined on a second plane substantially parallel to the first plane, and a plurality of side faces angled at between 10 degrees and 35 degrees from a direction perpendicular to the first plane, preferably between about 12 degrees and 30 degrees from the direction perpendicular to the first plane, for example about 15 degrees from the direction perpendicular to the first plane.

5. A radar apparatus according to claim 1 in which the housing has a monocoque structure in which the edges defining the frusto-pyramidal shape of the housing, and preferably at least three side faces of the housing, are a unitary component formed from a composite material, for example carbon fibre.

6. A radar apparatus according to claim 1 in which the housing comprises means for electromagnetically shielding the solid state transmitter and/or receiver from the external environment.

7. A radar apparatus according to claim 1 in which the bottom of the housing is defined at least in part by a re-entrant surface to improve structural rigidity of the housing.

8. A radar apparatus according to claim 1 in which the external shape of the housing as defined by a top face and side faces is shaped as a first frusto-pyramid having a base defined on a first plane and side faces angled between 10 degrees and 35 degrees from a direction perpendicular to the first plane, the housing having a re-entrant bottom surface substantially shaped as a second frusto-pyramid having the same base as the first frusto-pyramid and side faces angled between 45 degrees and 85 degrees from a direction perpendicular to the first plane.

9. A radar apparatus according to claim 1 in which the solid state transmitter and/or receiver is mounted in contact with means for removing heat from the housing.

10. A radar apparatus according to claim 1, further comprising a motor located within the housing, the motor being mechanically coupled to the antenna for rotating the antenna, preferably in which the antenna is directly driven by the motor.

11. A radar apparatus according to claim 10 in which the motor is coupled to the antenna via a carbon-fibre composite yoke.

12. A radar apparatus according to claim 1 further comprising an inverter and/or an AC/DC convertor.

13. A radar apparatus according to claim 1 in which at least one opening is defined through a side face of the housing, the at least one opening being closed by a removable panel.

14. A radar apparatus according to claim 13 in which one or more components of the apparatus are mounted on an internal surface of the removable panel such that the one or more component is removed from the apparatus when the removable panel is removed.

15. A radar apparatus according to claim 1 in which communication to and from the apparatus is by means of optic fibre.

16. A radar apparatus according to claim 1 having a total up-mast weight of less than 100 kg, preferably lower than 60 kg.
